(19) United States
(12) Patent Application Publication
(10) Pub. No.: US 2010/0007128 A1
(43) Pub. Date: Jan. 14, 2010

(54) LEAF FOR THE COMPOSITION OF A PHOTO ALBUM AND PHOTO ALBUM PROVIDED WITH SUCH A LEAF

(76) Inventor: Guido Peleman, Antwerpen (BE)

Correspondence Address: BACON & THOMAS, PLLC, 625 SLATERS LANE, FOURTH FLOOR, ALEXANDRIA, VA, 22314-1176, US

(21) Appl. No.: 12/443,786

(22) PCT Filed: Oct. 25, 2007
(86) PCT No.: PCT/IB07/03318

§ 371 Date: Mar. 31, 2009

(30) Foreign Application Priority Data
Nov. 6, 2006 (BE) 2006/0543

(51) Int. Cl. B42D 15/00

(52) U.S. Cl. 281/38

(57) ABSTRACT

Leaf for composing a photo album, comprising a support (2) provided with a layer of glue (4) on either side, which the layers of glue (4) include at least a mix of a self-adhesive glue and a hotmelt.

The present invention concerns a leaf for composing a photo album, comprising a support that is provided with a layer of glue on either side.

From IT BO2004A000592, leafs are already known whereby the above-mentioned layers of glue are made in the form of what is called hotmelt glue.

By a hotmelt is meant a thermally activated glue here, which melts under the influence of heat.

It is already known that, in order to compose a photo album, said leafs with photos are alternately piled up, after which the pile of leafs and photos is heated for example in an oven so as to make the glue melt, after which the glue is cooled again so as to make it set, in order to adhere the photos and the leafs so as to form a photo album.

A disadvantage of the known leafs is that, while the leafs and photos are being alternately piled, the photos shift in relation to the leafs, as a result of which these photos will not be centred or will not be glued onto the leafs in an entirely straight manner.

The present invention aims to remedy the above-mentioned and other disadvantages.

To this end, the present invention concerns a leaf for composing a photo album, comprising a support that is provided with a layer of glue on either side, whereby the above-mentioned layers of glue comprise at least a mix of a self-adhesive glue and a hotmelt.

A major advantage of such a leaf according to the invention is that, as the above-mentioned layers of glue consist of a mix of self-adhesive glue and hotmelt, these layers of glue have self-adhesive qualities, such that the photos already adhere to the respective leafs before the hotmelt melts and maintain their position in relation to said leafs.

The present invention also concerns a photo album that is provided with one or several leafs as described above.

In order to better explain the characteristics of the present invention, the following preferred embodiments of a leaf according to the invention for composing a photo album are given as an example only without being limitative in any way, with reference to the accompanying drawings, in which:

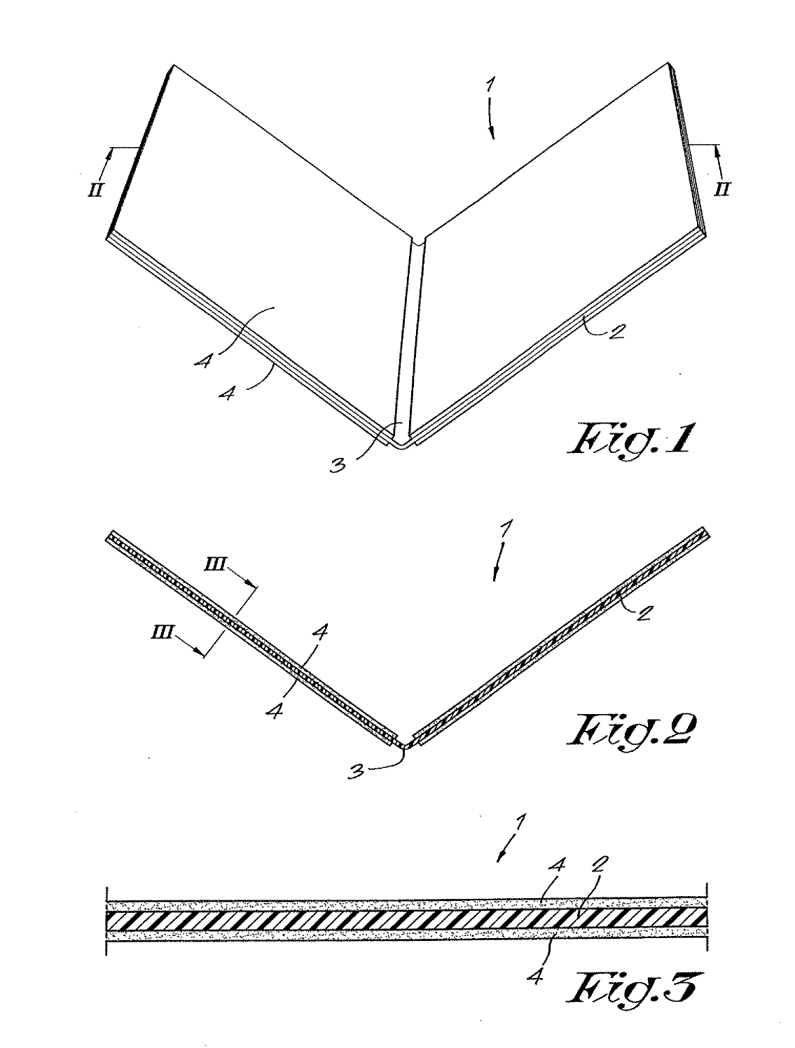

FIG. 1 schematically represents a leaf according to the invention, seen in perspective;

FIG. 2 represents a section according to line II-II in FIG. 1;

FIG. 3 represents a section according to line III-III in FIG. 2.

The figures represent a leaf 1 according to the invention for composing a photo album, provided with a support 2 which is in this case made in the shape of a piece of paper or cardboard.

The above-mentioned support 2 is in this case, but not necessarily, provided with a central folding line 3 which extends over the width of the leaf 1.

The above-mentioned leaf 1 is provided with a layer of glue 4 on either side, which in this case extends over practically the entire surface of the support 2, except for a narrow glue-free part around the above-mentioned folding line 3 in this case.

According to the invention, the above-mentioned layers of glue 4 comprise at least a mix of a self-adhesive glue and a hotmelt.

Every layer of glue 4 preferably contains some 25% of self-adhesive glue and some 75% of hotmelt.

According to a preferred characteristic, the above-mentioned hotmelt consist of ethylene vinyl acetate (EVA).

The softening temperature of the above-mentioned layers of glue 4, i.e. the temperature at which these layers of glue melt, in this case amounts to 85° C. to 95° C., whereas the viscosity of these layers of glue at 160° C. amounts to 3 to 3.6 Pa·s (3000 to 3600 centipoise).

In this case, the dimensions of the above-mentioned support 2 are practically the double of the dimensions of the photos to be glued.

The use of a leaf 1 according to the invention for composing a photo album is analogous to that of the leafs known until now and it is as follows.

In a first step, leafs 1 and photos are alternately piled on top of one another, whereby the leafs 1 are folded double according to the above-mentioned folding line 3 and whereby the piling is carried out such that two photos are inserted between every folded leaf 1 which are turned towards each other with their respective images.

As the above-mentioned layers of glue 4 are formed of a mix of self-adhesive glue and hotmelt, these layers of glue 4 have self-adhesive qualities, such that the photos are glued onto the respective leafs 1 and are kept in position in relation to these leafs 1.

Subsequently, the entire pile of leafs 1 and photos is put in an oven to be heated, in order to make the above-mentioned layers of glue 4 melt.

Finally, the whole is cooled again, as a result of which the layers of glue 4 set again, such that a bound bundle of leafs 1 with photos is obtained, forming a photo album.

According to a variant of a leaf 1 according to the invention which is not represented in the figures, the dimensions of the above-mentioned support 2 are practically half as large as the dimensions of the photos to be glued, and the leafs 1 are not provided with a folding line 3.

In this case, the photos are folded double, such that they are folded with their respective images towards the inside, after which these double-folded photos and the leafs 1 are alternately piled.

By subsequently heating and then cooling the pile of leafs and photos, a bound bundle forming a photo album is finally obtained in a manner analogous to the one described above.

It is clear that the present invention is not restricted to the examples described above and that the dimensions of the leafs 1 and the photos may vary.

Nor is it necessary for the leafs 1 according to the invention to be provided with a layer of glue 4 over their entire surface; on the contrary, such a layer of glue 4 may extend over only a part of the surface.

The present invention is by no means restricted to the embodiments described as an example and represented in the accompanying drawings; on the contrary, such a leaf according to the invention for composing a photo album can be made in all sorts of shapes and dimensions while still remaining within the scope of the invention.

1. Leaf for composing a photo album, comprising a support provided with a layer of glue on either side, said layers of glue comprising at least a mix of a self-adhesive glue and a hotmelt.

2. Leaf according to claim 1, wherein the layers of glue contain about 25% of self-adhesive glue and about 75% of hotmelt.

3. Leaf according to claim 1, wherein the hotmelt consists of ethylene vinyl acetate (EVA).

4. Leaf according to claim 1, wherein the layers of glue have a softening temperature of 85° C. to 95° C.

5. Leaf according to claim 1, wherein the layers of glue have a viscosity of 3 to 3.6 Pa·s (3000 to 3600 centipoise) at 160° C.

6. Leaf according to claim 1, wherein the layers of glue extend over substantially the entire surface of the support.

7. Leaf according to claim 1, including a central fold line extending over the width of the leaf.

8. Leaf according to claim 7, said fold line provided in a glue-free part of the leaf.

9. Leaf according to claim 1, wherein the dimensions of the support are substantially twice the dimensions of photos to be glued on the leaf.

10. Leaf according to claim 1, wherein the dimensions of the support are substantially one-half as large as the dimensions of the photos to be glued on the leaf.

11. Photo album comprising at least one leaf according to claim 1.
